(19) United States
(12) Patent Application Publication
(10) Pub. No.: US 2006/0007930 A1
(43) Pub. Date: Jan. 12, 2006

(54) Downlink multicast method in wireless internet protocol system

(76) Inventor: Jheroen P. Dorenbosch, Paradise, TX (US)

Correspondence Address: MOTOROLA, INC., LAW DEPARTMENT, 1303 E. ALGONQUIN ROAD, SCHAUMBURG, IL, 60196, US

(21) Appl. No.: 10/887,660

(22) Filed: Jul. 9, 2004

(51) Int. Cl. H04L 12/28

(52) U.S. Cl. 370/390

(57) ABSTRACT

A method for determining multicast versus unicast of packet data is a wireless communication system establishes (102) a target member set which represents the wireless terminals (10-14) served by an access point (30-32) which wireless terminals a members of a multicast group. The access point receives (104) the packet data. The access point next determines (106) a destination subset of the target member set of wireless terminals. The destination subset is those wireless terminals which are to receive the packet data.

### BACKGROUND OF THE INVENTION

The present invention pertains to wireless communication systems and more particularly to multicast versus unicast decisions for efficient use of communication system resources.

Multicast can be used for conferencing, mass distribution of streaming media and for dispatch. For example, several dispatch systems, like iDEN, exclusively use multicast even if there are only two participants in a dispatch call. This enables attractive and elegant architectures. Multicast is a one broadcast to many receivers. Unicast is one broadcast to one receiver.

However, these architectures can not easily be applied in 3G and 4G wireless IP systems like 802.11 and Flarion. In such systems downlink multicast is significantly more expensive than unicast. The cost of multicast is high because it is difficult to use acknowledged transmission, power management, code selection, modulation selection and header compression.

An additional difficulty in mobile IP (internet protocol) systems is that a controller can't determine where wireless terminals (WTs) are attached. In particular, it becomes difficult and expensive for the controller to know how many WTs are attached at a transmitter.

Transmitters in these systems can behave like IP switches or bridges (in 802.11) or like routers like Flarion Radio Routers.

Accordingly it would be highly advantageous to have a method for determining whether to use multicast or unicast downlink transmission when transmitting to a multicast group.

### BRIEF DESCRIPTION OF THE DRAWINGS

FIG. 1 is a block diagram of a wireless communication system in accordance with the present invention.

FIGS. 2 through 9 are flow charts of a method for unicast versus multicast determination in accordance with the present invention.

### PREFERRED EMBODIMENT OF THE INVENTION

The present invention includes permitting a system to make a choice between unicasting and multicasting a packet when transmitting the packet to a multicast group. When a originator of a packet specifies the use of multicast, a wireless Access Point (AP) can still chose between using replicated unicast and multicast in the cell or sectors it supports. Individual APs make this decision independently; based on a cost comparison between unicast and multicast. The system may include a single AP.

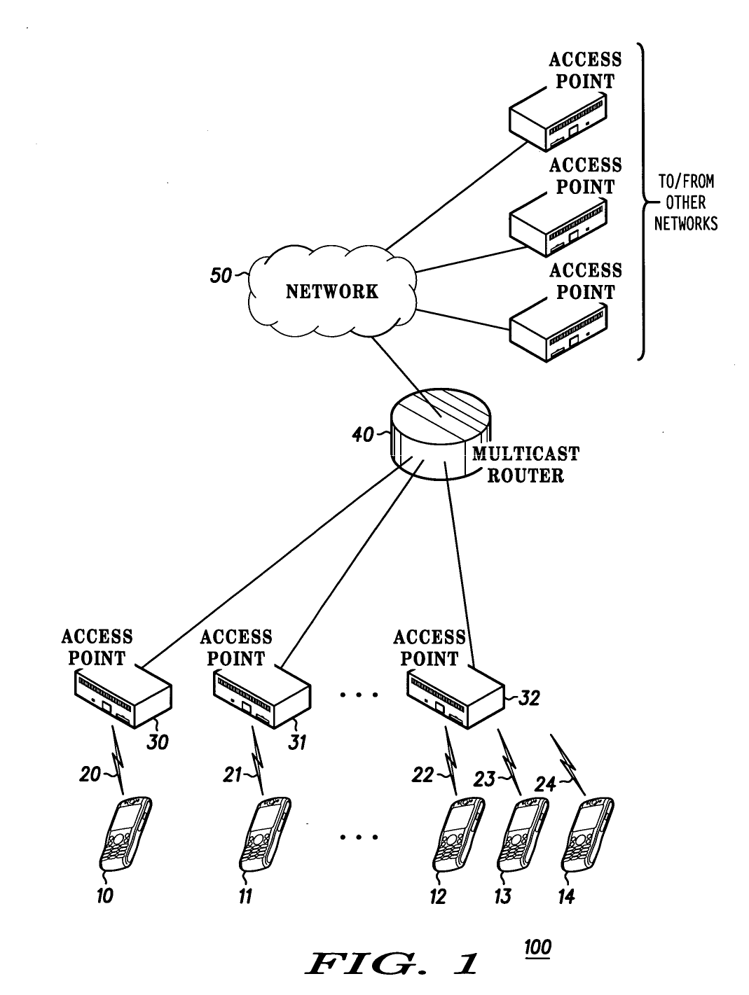

Referring to FIG. 1 a block diagram of a wireless internet protocol (IP) communication system 100 is shown. The communication system 100 serves wireless terminals (WTs) 10-14 via one or more Access Points 30-32. Access Points 30-32 are connected to a network 50. The network supports multicast, preferably through the use of one or more multicast IP routers 40. Multicast packets are routed between routers in the network using one of many well-known Multicast Routing Protocols, such as PIM-SM. The network 50 also supports unicast.

APs 30-32 may themselves be multicast routers (e.g. Flarion Radio Routers) each serving one or more wireless cells or sectors (not shown). APs 30-32 can also be IP switches or bridges (E.g. 802.11 Access Points). Several such APs can be connected to a multicast router 40 via a common IP subnet. Each such AP normally will service a single cell. The protocols used in the cells or sectors support unicast as well as multicast, preferably through the use of IP unicast and multicast. Preferably each wireless sector is a separate IP subnet, but alternatively multiple sectors serviced by the same Access Point may form a single IP subnet. APs 30-32 may support one or more WTs 10-14 by sending information to the WTs and by receiving information from the WTs over wireless links 20-24. The information may be bits, bytes, packets, messages, or steams of bits, bytes, packets or messages. Below we will refer to such information as packets.

APs may serve WTs by sending and receiving packets using unicast or multicast. WTs 10-14 will each have one or more unique identifiers, preferably layer 3 IP addresses, and a unique layer 2 address, such as a MAC address. An AP uses these unique addresses to send or unicast downlink packets to an individual WT. Unique identifiers or unicast addresses are also used in an uplink packet and enable an AP to determine which of the WTs in the cell has sent the packet.

A WT 10-14 can belong to, or be a member of zero or more multicast groups, with each multicast group represented by a group multicast address or group address. An AP uses a group address to multicast downlink packets to all WTs in the cell that belong to the group. A WT can use a group address to multicast uplink packets to the group.

An AP 30-32 can receive a multicast packet in different ways. The AP can receive a multicast packet from the network. Packets received from the network may be received from the network 50 via a multicast router 40 or from other APs via a common subnet. If the AP is itself a multicast router it will receive the packet on its network interface for transmission on one or more interfaces connected to the sectors or cells served by the AP. If the AP is a switch connected to a multicast router 40 via a common subnet, the AP will receive the packet on its subnet interface for transmission on the sectors or cells served by the AP. The AP can also receive a multicast packet that has been transmitted by one of the served WTs on the uplink. The AP can determine the ID of the sending WT by inspection of the source address of the packet. The AP then forwards the received packet to its wired interface with the network 40. If the AP is a router, it may use an interface designated to be part of the multicast distribution tree for the multicast group. If the AP is a switch, it forwards the packet to its common subnet interface, so that multicast router 40 can forward the packet to the network 50. In the latter case, all other APs on the common subnet will also receive the multicast packet on their subnet interface.

In general, in wired networks all hosts connected to a common subnet will see all packets transmitted on the subnet by any other host. Hence when one host transmits a multicast packet onto the subnet, there is no need to retransmit that packet on the same subnet. This is no longer true in wireless systems. For example, if WT 14 transmits a multicast packet on the uplink 24 and the AP 32 receives the packet, there is no guarantee that other WTs 12-13 in the same cell will be able to receive the multicast packet. For this reason it is customary that AP will transmit or echo on the downlink any multicast packet received on the uplink. This is done to give any served WTs that are members of the multicast group an opportunity to receive the multicast packet. Similarly, customarily, other APs connected to a common subnet with the AP that receives the multicast packet on the uplink will receive the packet on the subnet interface and transmit or echo it on the downlink to give any served member WTs an opportunity to receive the multicast packet.

Normally downlink multicast from an AP in one sector is independent from downlink multicast in other sectors; downlink multicast in the one sector is normally only received by WTs in that sector. In rare cases, downlink multicast is coordinated across multiple sectors serviced by a single AP; downlink multicast from the AP is intended to be received by the WTs in any one of the coordinated multiple sectors.

Below we will use the term cell for a cell or sector with independent multicast as well as for multiple sectors with coordinated multicast.

For downlink unicast transmission of a packet, APs and WTs use additional information e.g. from acknowledgements, signal quality reports and other feedback to estimate the link quality of the wireless link between an AP 30-32 and a WT 10-14. The link quality estimates can then be used to optimize unicast transmission. Using well-known methods, APs can chose an optimal combination of power, coding rate and repeats to minimize one or more of the total transmit power, the total number of symbols or slots and the total time needed to transmit one or more specific packets to a specific WT. This optimization reduces the cost of unicasting the packet. For downlink multicast transmission of a multicast packet, APs normally use transmission parameters, such as power, coding rate and repeats that is sufficient for the packet to be received by all member WTs with sufficient reliability. Often the AP simply assumes that the WT is at or near the edge of the coverage region and uses a predetermined combination of high power and low coding rate. Clearly, in most cases multicasting a packet to a single WT has a higher cost than unicasting the same packet to the same WT. However, multicasting a packet to a multiple member WTs may or may not be more costly than unicasting the same packet to the same WTs.

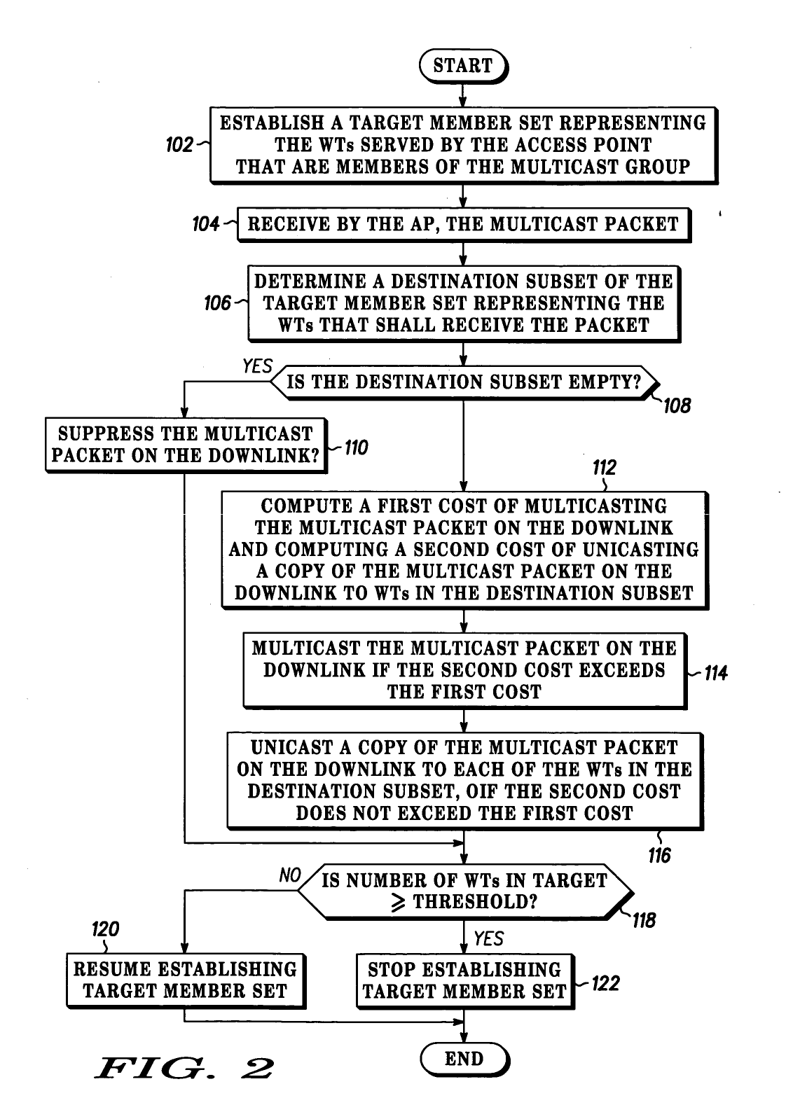

What is needed is a method and apparatus to minimize the cost of transmitting a multicast data packet from an AP 30-32 to a multicast group on a wireless downlink 20-24 in a wireless system. Referring to FIG. 2, a preferred embodiment is described where the AP establishes 102 a target member set for a multicast group representing a wireless terminal of the plurality of wireless terminals 20-24 being served in a cell by the access point which is a member of the multicast group. The AP preferably establishes the target set such that it represents all WTs that are in the cell that are members of the multicast group. The AP 30-32 receives 104 the multicast packet and determines that is directed to the multicast group. Often a multicast packet must be transmitted to all group members of the multicast group that are in the cell, or to the target set, but this is not always so. Not all WTs that are members of a group need to be the destination of each multicast packet that is directed to the group. Therefore the AP determines 106 the destination subset of the target member set representing ones of the plurality of wireless terminals to receive the multicast packet data. Normally the subset is equal to the target set but in many cases the determination by the AP may result in the exclusion or removal of one or more member WTs from the subset, which can reduce the cost of transmission of the packet.

The AP 30-32 preferably establishes 102 the target set of served group member wireless terminals (WTs) 10-14 for each multicast group it serves. It must do this separately for each cell it serves. The AP does not need knowledge of group members at other access points (APs) 30-32. The AP also collects a unicast address for each WT in the target set.

One could invent any number of proprietary protocols between the AP 30-32 and WTs 10-14 to establish target sets. However, the AP can use novel methods that are transparent to the infrastructure and the WTs.

For one novel method, the AP modifies IGMP or MLD signaling. IGMP is the IETF IPv4 Internet Group Management Protocol and MLD is the IPv6 Multicast Listener Discovery protocol. These protocols are available as RFC 3376 and RFC 2710 at www.ietf.org. Below we often refer to a message as an IGMP Join message, a Join message or a Join. The official name for this message is Membership Report in IGMP and Multicast Listener Report in MLD.

Below we will first describe prior art use of IGMP in a wired network. Next we describe multicast on a wireless IP network and prior art use of IGMP in wireless IP networks.

IGMP is used between a subnet router such as multicast router 40 or a Radio Router AP and the group member hosts. With IGMP the router can learn whether there are 0 or any (>=1) member hosts on the subnet. A prior art router does not track whether there is more than one member on the subnet.

To indicate that at least one member of a multicast group is present, a member host sends an IGMP Join message. It sends the Join to the multicast address of the group. The Join multicast packet is transported on the wired subnet and hence the router and all other hosts will get a copy of the packet.

On reception of the IGMP Join the router adds the group to the list of groups for which there is at least one member on the subnet. Other members of the multicast group will also decode the packet sent to the multicast group address. They detect the Join and per IGMP or MLD protocol will not attempt to send a Join themselves. This reduces redundant Join messages.

Routers regularly poll for group membership by sending a General Membership Query. The default polling rate is 125 seconds. Hosts reply by sending a Membership Report after a random delay. They reply to the group multicast address. Again, other members will decode the report and those that do so do not have to send a report themselves.

When a member host leaves the subnet, it should send an IGMP or MLD Leave message. The Leave is sent to the group address. Since a prior art router does not count group members, it needs to check whether any group members are left. It can do so by sending a Specific Group Membership Query to the group address. The members, again, respond with a Membership Report on the group address after a random delay. This way normally only one member will respond. If no members respond to a membership query, the router will remove the group from the list of groups for which there is at least one member on the subnet. If a router has no more members on any subnet it preferably it uses the Multicast Routing Protocol to prune the distribution tree for the multicast group.

In a prior art system, when a WT host at an AP sends (multicasts) an IGMP Join or a Membership Report, the report will reach all other group members at all Access Points attached to the same subnet. This will have the effect that other members at other APs on the same subnet will not send a Join/Membership Report.

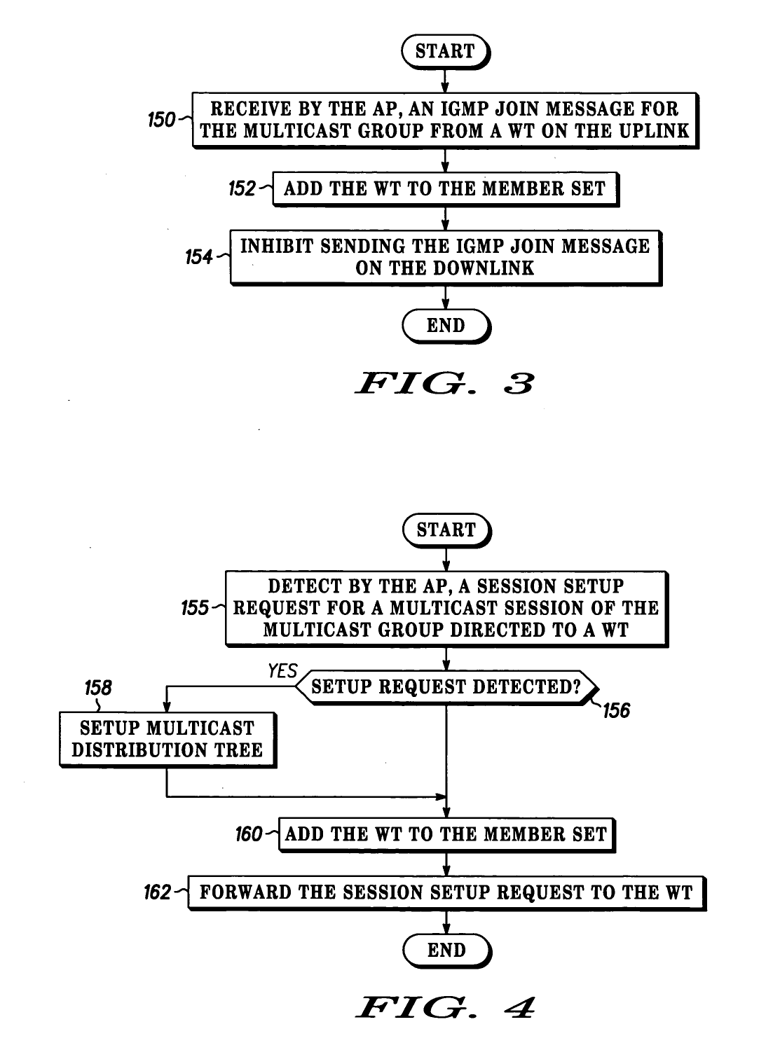

This method modifies the treatment of IGMP and MLD multicast packets in the APs 30-32 and is shown in FIG. 3. Using this modification, the AP will learn which group members are present in a cell. This enables the AP to establish a target member set for a multicast group for that cell. The method modifies the treatment of IGMP Joins, IGMP Leaves and IGMP Membership Reports by the AP. The AP maintains a target member set or a list of member Identifiers (Ids) for each multicast group it serves. The IDs preferably are unicast layer 2 (MAC) addresses but can also be or unicast layer 3 (IP) addresses or other unique identifiers. The AP executes the invention when it receives 150 a multicast packet for the multicast group from a WT on the uplink. To retain proper multicast distribution, regardless of the outcome of the invention, the AP will forward the packet towards the wired infrastructure, if so required by prior art rules or Multicast Routing Protocols. The AP determines whether a received multicast packet is an IGMP Join/Leave or a Membership Report. If so, the AP does not transmit, or inhibits 154 the transmission of the packet on the downlink. As a result, no other group member WTs will receive the Join message and, hence, per IGMP/MLD protocol all group members will send a Join. Similarly, all member WTs will also send a Membership Report in response to a Membership Query. Also, if it is an IGMP Join, IGMP Leave or Membership Report, the AP adjust a target member set for the multicast group. For a Join or a Membership Report from a WT that is not yet in the target set, the AP adds 152 the WT to the target set. The AP captures the ID of the member and adds the ID to a list, preferably storing the unicast layer 2 address of the member. For a Leave, the AP removes the WT from the target set. To deal with reports, the AP may clear the target set at the time it sends a Membership Query and add 152 WTs back into the set as it receives 150 Membership Reports, this way adding 152 all members and capturing identities of all members.

When the AP receives a Leave the AP may opt not to send a new membership query as prescribed by the IGMP protocol. After all, it already has a complete list of all the members it is serving.

When implemented at an Access Point that is a switch connected to a common subnet, the IGMP Join, Leave or Membership Report messages can come from the uplink or from a WT at an other AP via the common subnet. In this case the AP will also inhibits 154 the transmission of the packet on the downlink.

Multicast packets are often used in the context of a session or a call. For example, the packets may be part of a video that is being multicast from a site to a large number of WTs 10-14 at a plurality of APs 30-32. Multicast packets may also be used during a dispatch call to transport voice from a talker to one or more listeners. They may also be used for telephone calls, conference calls and for bearer and signaling or control information. The use of multicast packets in a session often is announced through the use of a session initiation control protocol or a session announcement protocol. For example, a session controller may invite the a group of participants in a multicast session by sending each member an INVITE messages on the member's unicast address. This enables an alternative method to establish the target member set for a multicast group. For this method, shown in FIG. 4, the AP inspects unicast and multicast uplink and downlink packets to determine whether they contain signaling and control messages for a session that uses multicast packets. When the AP detects 155 a session setup request for a multicast session directed to the wireless terminal the AP will add 160 the wireless terminal to the target member set and forward 162 the session setup request to the wireless terminal.

Detection of the use of multicast packets during session setup has an additional advantage. Normally an AP cannot set up a multicast distribution tree until it gets a Join request from one of the member WTs. With this method the AP can detect a multicast session before any WT in the multicast group learns about it. In response to the detection of the session setup request for a multicast session, the AP can proactively initiate a setup or setup 158 the multicast distribution tree for the multicast group, for example by sending an IGMP Join or a PIM-SM Join towards the network 50.

The use of this method is not limited to the detection of downlink session setup messages or session announcement messages. The AP may also observe uplink signaling and control messages related to a session. For example, referring to FIG. 7, an AP may detect 180 a session setup request for a multicast session of the multicast group directed to one of the plurality of wireless terminals and observe 182 a response or an indication from an invited wireless terminal that the WT does not want to participate in a multicast session. The WT may be busy, or the user of the WT may not be interested in answering a call, the WT is switched off or the WT moves out of the coverage of the cell. The AP can then remove 184 that WT from the subset of WTs that are to be the destination of the multicast packets. Alternatively, the AP can remove that WT from the target set for the group.

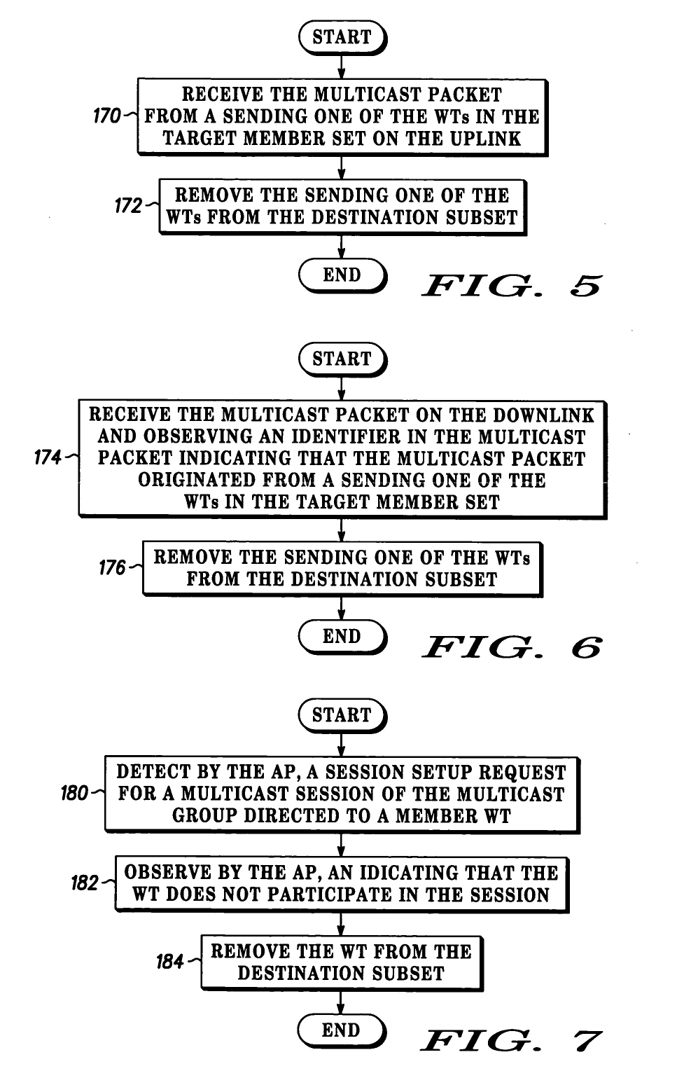

APs 30-32 in wireless systems customarily retransmit or echo on the downlink the multicast packets that are received on the uplink. This is done so that other group members in the same cell as the WT that sends the packet on the uplink have a chance to receive the packet. For example, if WT 14 sends a multicast packet on the uplink 24 to AP 32, AP 32 will echo the packet on the downlink so that WTs 12 and 13 can also receive the packet. If the APs 30-32 are on a common subnet, APs 30 and 31 will also send the packet on the downlink so that WTs 10 and 11 can receive it. Such downlink transmission may be useful to WTs 10-13 but are not useful to WT 14, since WT 14 has sent the packet itself. Therefore, as is shown in FIG. 5, when the AP receives 170 a multicast packet data on an uplink from a sending one of the plurality of wireless terminals in the target member set, the AP can remove 172 the sending one of the plurality of wireless terminals from the destination subset.

Uplink packets from a WT may also be echoed or retransmitted by other entities in the network 50. For example, in FIG. 6 the WT may be a talker in a dispatch group and the packet may be a speech packet sent by the talker WT. The entity in the network 50 may be a part of a multicast distribution network that sends the speech packet back to all group members using multicast. Thus the AP may receive 174 a multicast packet data from the network for transmission on the downlink and observing an identifier in the multicast packet data indicating that the multicast packet data originated from a sending one of the plurality of wireless terminals in the target member set. The AP can then remove 176 the sending one of the plurality of wireless terminals from the destination subset. Examples of identifiers that the AP can observe may be the layer 3 source address, the layer 2 source address and the Synch Source identifier in an RTP packet. The identifier may also be a unique numeric or alphanumeric string attached to the packet by the sending WT, maybe containing one or more of a sequence number, a timestamp, a name, or a serial number.

Maintenance of target member lists and destination subset requires a certain amount of processing power and storage space. A variation is helpful to reduce the amount of processing power and storage space needed to maintain the sets. Referring to FIGS. 1 and 2, the AP counts the number of members in the target set for a group. The AP compares 118 the number against a predetermined first threshold. When the number reaches the first threshold the AP ceases 122 the further establishing the target member set and stops the addition of members to the target set. The AP may for example multicast a Membership Report for the group on the downlink to prevent all further Joins or Membership Reports from the members. When the AP later receives a Leave, it may no longer know how many members are in its cell. The AP may apply a second threshold. Each time the AP receives a Leave or another (e.g. timeout) indication that a member may have left the cell, it decrements a count that represents the minimum number of members known to be present in the cell and compare it against a second threshold 118. When the count dips below the second threshold, the AP resumes 120 the establishing of the target member set. To check the Ids of the current members, the AP can issue a Membership Query and obtain the actual target set member population. If the target membership is still above the first threshold, the AP does not track the target set membership; if the target set membership count is below the second threshold, the AP again starts to track individual member IDs.

Again referring to FIG. 2, after establishing the target member set for the multicast group, receiving a multicast packet for the group and determining a destination subset of a target member set of those member WTs that should receive the multicast packet on the downlink, the AP checks 108 whether the destination subset is empty. If destination subset is empty the AP suppresses 110 the multicast packet on the wireless downlink; the AP does not transmit the packet to the target member set. For example, AP 30 may determine that the target set for a multicast group is a single WT 10. When AP 30 receives an uplink multicast packet from WT 10, it removes the WT from the destination subset. The subset is now empty and the AP does not echo the packet on the downlink.

If the destination subset is not empty the AP has to transmit the multicast packet on the wireless downlink. To improve the transmission cost, the AP compares the costs of multicasting and of unicasting the packet to all WTs in the destination subset. To do so, the AP computes 112 a first cost of multicasting the multicast packet data on the wireless downlink and computes a second cost of unicasting a copy of the multicast packet data on the wireless downlink to the plurality of wireless terminals in the destination subset.

A preferred strategy to calculate the costs is to first calculate the first cost of multicast. Normally this calculation is straightforward because it assumes a predetermined, rather high power level, code rate, modulation combination, no acknowledgements or retransmissions, and no header suppression. A given combination of code rate (e.g. 1/6, 5/6) and modulation (e.g. 4 QAM vs. 16 QAM) results in a specific number of channel symbols or a specific amount of channel time needed to transmit the packet. A high power level uses a high fraction of the total available power and results in interference in neighbor cells or on nearby frequencies. The above considerations can be combined into a cost for multicasting the packet.

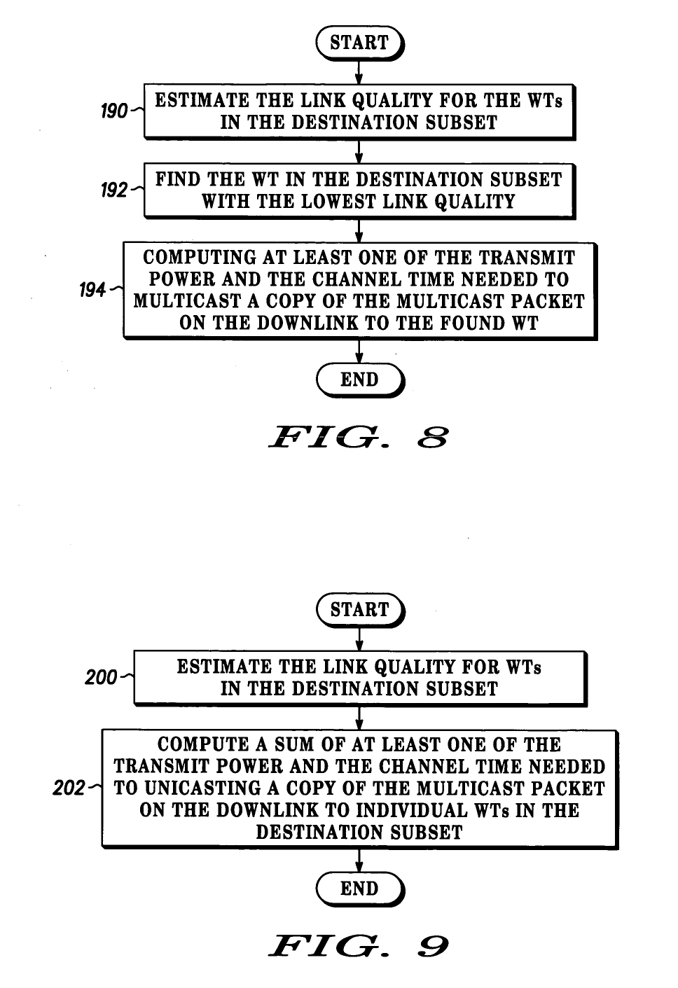

Optionally a wireless system may multicast in a more sophisticated way and calculate the cost accordingly. This shown in FIG. 8. An AP may estimate 190 the link quality for the destination WTs. The AP can then find 192 the WT with the lowest quality. The AP can select a combination the transmit power level, code rate, modulation that will transmit with good reliability to that WT. The AP can then use the adjusted combination to multicast the packet to the destination subset. With this option, to compute the first cost of multicasting the multicast packet data on the wireless downlink, the AP computes at least one of the transmit power, code rate, modulation and channel time for the selected combination.

The preferred strategy proceeds to calculate the cost of unicasting a copy of the multicast packet to each of the WTs in the destination subset. The preferred implementation is shown in FIG. 9. To calculate the second cost, the AP can estimate 200 the link quality for wireless terminals in the destination subset; and compute 202 the sum of at least one of a transmit power or a channel time to unicast a copy of the multicast packet data on the wireless downlink to a wireless terminals in the destination subset. Link quality estimates may have to be updated from time to time throughout a multicast session.

Preferably the AP starts by calculating the cost for the WT that has the lowest link quality, then calculates the cost for the WT with the next lowest quality, and so on, accumulating the costs for the WTs in the destination subset. As soon as the accumulated second cost exceeds the first cost of using multicast, the AP can stop the calculation.

Calculation cost for an unicast transmission to a individual WT is complex. To calculate the second cost of unicasting a copy of the multicast packet to the WTs in the destination subset the AP may estimate the current link quality for the wireless terminals in the destination subset and computing the sum of at least one of a transmit power, interference or a channel time to unicasting a copy of the multicast packet data on the wireless downlink to a wireless terminals in the destination subset. If no current link quality information is currently available for a WT, the AP may use a recent estimate or assume that the WT is somewhere near the edge of the coverage.

To unicast to a WT 10-14, an AP 30-32 can use lower power or use less channel time thereby risking transmission errors. When such a unicast error occurs the AP can retransmit the packet. The effect on cost of retransmissions must be considered in the cost computation.

If the second cost exceeds the first cost the AP will multicast 114 of FIG. 2, the packet data on the wireless downlink. If the first cost exceeds the second cost the AP 30-32 unicasts 116 a separate copy of the multicast packet data on the wireless downlink 20-24 to each of the plurality of wireless terminals in the destination subset. In other words, the AP uses replicated unicast for the multicast packet.

Thus an advantage of using replicated unicast is that the AP can independently optimize the unicast transmission to each WT and use an optimal power level, coding rate and modulation. An additional advantage occurs when the multicast packet is part of a sequence of multicast packets, as will be the case for a multicast session. In that case the AP can use header compression for each of the WTs of the destination subset. Such header compression requires that the AP maintains an independent compression context for each WT in the destination subset. Header compression is normally done in the context of a session. Hence, normally a transmitter will use the same transmission mode (unicast/multicast) for all multicast packets that belong to the same session. Since header compression can give huge reductions in the number of symbols or in the amount of channel time needed to transmit a packet, the AP must consider the effect of header compression on the second cost. The AP must also calculate the cost component associated with synchronizing and re-synchronizing the compression and decompression engines.

To obtain accurate link quality estimates and to be able to rapidly transmit the multicast packet, the AP or the system may need to take or keep each destination WT out of idle or sleep mode and bring it into a mode in which downlink quality can be estimated (e.g. hold mode, wake mode, or ON state). A preferred method for bringing the WT out of sleep mode and to prevent a WT from entering sleep mode prematurely can be implemented if the multicast session is announced to the WT by a session invitation message, such as a unicast Session Initiation Protocol INVITE to each individual WT. The Session Initiation Protocol (SIP) is defined by the Internet Engineering Task Force (IETF) in a document designated RFC 3261, which is available at www.ietf.org/rfc. The INVITE sequence of messages may specify that the session bearer is consists of multicast packets. The multicast address can be conveniently signaled in the SDP that is part of the session setup messages. The WTs are preferably programmed to come out and stay out of sleep mode for the duration of the session. A other preferred method for bringing the WT out of sleep mode and to prevent a WT from entering sleep mode prematurely is to program the WT to come out of sleep mode and to stay out of sleep mode for a predetermined duration after receiving any multicast packet.

The preferred way for an AP to unicast a multicast packet to a WT in the destination set is to collect the layer 2 unicast address of wireless terminals represented in the target member set; to receive a multicast packet that is a layer 3 multicast packet; and to unicast a copy of the layer 3 multicast packet data to the layer 2 unicast address of each of the plurality of wireless terminals in the destination subset. This allows for transparency at the application level. For example, if the multicast packet is encrypted, the AP does not have to decrypt the packet and re-encrypt each copy for each destination WT. It also allows for independent unicast encryption at layer 2. For example, an AP 30-32 and a WT 10-14 may share an encryption key and use it for encryption of a packet on the air link in such a way that third party WTs cannot decode the packet, even if they are members of the multicast group.

During a multicast session, members may join or leave the multicast group and link quality estimates may change. For this reason the AP may want to reevaluate the transmit mode form time to time. For example, the choice between unicast and multicast for a dispatch call can change from talk-spurt to talk-spurt. If the talker in a group call is in the AP's cell, the number of WTs in the destination subset for the bearer is one less then when the talker in another cell. Also as the number of participants in an ongoing call changes, the AP may change between multicast and replicated unicast. Packets belonging to the same talk-spurt or session can be sent in different modes. For example, a talk-spurt can start as replicated unicast but may end as multicast because the link quality of many of the participants degrades drastically or because several additional participants join.

In another embodiment, the AP calculates the second cost for the target member set. For this embodiment, the AP establishes the target member set representing a wireless terminal of the plurality of wireless terminals served by the access point which is a member of the multicast group; receives a multicast packet data for the multicast group; computes a first cost of multicasting the multicast packet data on the wireless downlink as described above; and computes a second cost of unicasting a copy of the multicast packet data on the downlink to wireless terminals in a target set. To calculate the second cost, the AP can estimate the link quality for wireless terminals in the target set and compute the sum of at least one of a transmit power or a channel time to unicast a copy of the multicast packet data on the wireless downlink to a wireless terminals in the target set.

If the second cost exceeds the first cost the AP will multicast 114 the packet data on the wireless downlink.

If the first cost exceeds the second cost the AP 30-32 unicasts a separate copy of the multicast packet data on the wireless downlink 20-24 to each of the plurality of wireless terminals 10-14 in the target set.

Although the preferred embodiment of the invention has been illustrated, and that form described in detail, it will be readily apparent to those skilled in the art that various modifications may be made therein without departing from the spirit of the present invention or from the scope of the appended claims.

1. A method for transmitting multicast packet data to a multicast group on a wireless downlink in a wireless system, the wireless system having an access point serving a plurality of wireless terminals, the method comprising the steps of:
establishing a target member set representing a wireless terminal of the plurality of wireless terminals being served by the access point which is a member of the multicast group;
receiving, by the access point, the multicast packet data; and
determining a destination subset of a target member set representing ones of the plurality of wireless terminals to receive the multicast packet data.

2. The method of claim 1, wherein there is further included a step of suppressing the multicast packet data on the wireless downlink, if the destination subset is empty.

3. The method of claim 1, wherein if the destination subset is not empty, there is further included steps of:
computing a first cost of multicasting the multicast packet data on the wireless downlink; and
computing a second cost of unicasting a copy of the multicast packet data on the wireless downlink to the plurality of wireless terminals in the destination subset.

4. The method of claim 3, wherein the step of computing the first cost includes steps of:
estimating a link quality of wireless terminals in the destination subset;
finding a wireless terminal in the destination subset having a lowest link quality; and
computing at least one of a transmit power or a channel time needed to multicast a copy of the multicast packet data on the wireless downlink to the wireless terminal having the lowest link quality.

5. The method of claim 3, wherein the step of computing the second cost includes steps of:
estimating a link quality for wireless terminals in the destination subset; and
computing a sum of at least one of a transmit power or a channel time to unicasting a copy of the multicast packet data on the wireless downlink to a wireless terminals in the destination subset.

6. The method of claim 3, wherein there is further included steps of:
multicasting the multicast packet data on the wireless downlink; if the second cost exceeds the first cost; and
unicasting a copy of the multicast packet data on the wireless downlink to each of the plurality of wireless terminals in the destination subset, if the first cost does exceed the second cost.

7. The method of claim 6, wherein the step of unicasting a copy of the multicast packet data further includes preventing the wireless terminal in the destination subset from entering a sleep mode.

8. The method of claim 6, wherein the step of multicasting a copy of the multicast packet data further includes suppressing a header when unicasting the multicast packet data to at least one of the wireless terminals in the destination subset.

9. The method of claim 1, wherein the step of establishing includes the steps of:
receiving, by the access point, one of an IGMP membership report message and a MLD multicast listener report message for the multicast group from a first wireless terminal on a wireless uplink;
adding the first wireless terminal to the target member set; and
inhibiting sending a report message on the wireless downlink.

10. The method of claim 1, wherein the step of establishing further includes steps of:
detecting, by the access point, a session setup request for a multicast session directed to the wireless terminal;
adding the wireless terminal to the target member set, and
forwarding the session setup request to the wireless terminal.

11. The method of claim 10, wherein the access point, in response to the step of detecting of the session setup request for a multicast session, initiates a setup of a multicast distribution tree.

12. The method of claim 1, wherein there is further included steps of:
ceasing the step of establishing the target member set when a number of wireless terminals in the target member set exceeds a first threshold; and
resuming the step of establishing the target member set when the number of wireless terminals in the target member set is below a second threshold.

13. The method of claim 1, wherein:
the step of receiving by the access point includes a step of receiving the multicast packet data on an uplink from a sending one of the plurality of wireless terminals in the target member set; and
the step of determining a destination subset includes a step of removing the sending one of the plurality of wireless terminals from the destination subset.

14. The method of claim 1, wherein there is further included:
the step of receiving by the access point further includes receiving the multicast packet data from the network;
observing an identifier in the multicast packet data indicating that the multicast packet data originated from a sending one of the plurality of wireless terminals in the target member set; and
the step of determining the destination subset further includes removing the sending one of the plurality of wireless terminals from the destination subset.

15. The method of claim 1, wherein the step of determining the destination subset further includes:
detecting, by the access point, a session setup request for a multicast session of the multicast group directed to one of the plurality of wireless terminals;
observing, by the access point, an indication of one wireless terminal which does not participate in a multicast session;
one step of:
removing the one wireless terminal from the destination subset; and
removing the one wireless terminal from the target set.

16. The method of claim 1, wherein:
the step of establishing further includes establishing a layer 2 unicast address of each wireless terminal represented in the target member set;
the step of receiving further includes receiving a layer 3 multicast packet data; and
there is further included a step unicasting a copy of the layer 3 multicast packet data to the layer 2 unicast address of each of the plurality of wireless terminals in the destination subset.

17. The method of claim 1, wherein the access point includes at least one of:
an 802.11 access point; and
an internet protocol radio router.

18. A method for transmitting multicast packet data to a multicast group on a wireless downlink, a wireless system having an access point serving a plurality of wireless terminals, the method comprising the steps of:
establishing a target member set representing a wireless terminal of the plurality of wireless terminals served by the access point which is a member of the multicast group;
receiving, by the access point, the multicast packet data;
computing a first cost of multicasting the multicast packet data on the wireless downlink; and
computing a second cost of unicasting a copy of the multicast packet data on the downlink to wireless terminals in a target set.

19. The method of claim 18, wherein there is further included a step of multicasting the multicast packet data on the wireless downlink, if the second cost exceeds the first cost.

20. The method of claim 18, wherein there is further included a step of unicasting a copy of the multicast packet data on the wireless downlink to each of the plurality of wireless terminals in a destination subset, if the first cost exceeds the second cost.
